(19) United States
(12) Patent Application Publication
(10) Pub. No.: US 2010/0006756 A1
(43) Pub. Date: Jan. 14, 2010

(54) CHARGED PARTICLE BEAM APPARATUS AND METHOD FOR GENERATING CHARGED PARTICLE BEAM IMAGE

(76) Inventors: Norimichi Anazawa, Tokyo (JP); Jun Nitta, Tokyo (JP); Michio Ohshima, Tokyo (JP); Tatenori Jinriki, Tokyo (JP); Naoyuki Nakamura, Tokyo (JP); Akira Yonezawa, Tokyo (JP); Ken-ichi Kobayashi, Tokyo (JP); Hao Zhang, Tokyo (JP)

Correspondence Address: STAAS & HALSEY LLP, SUITE 700, 1201 NEW YORK AVENUE, N.W., WASHINGTON, DC, 20005, US

(21) Appl. No.: 11/917,838

(22) PCT Filed: Jun. 15, 2006
(86) PCT No.: PCT/JP2006/312061

§ 371 Date: Jul. 23, 2009

(51) Int. Cl. G01N 23/225

(52) U.S. Cl. 250/310; 250/311

(57) ABSTRACT

When the surface of a semiconductor wafer, a photomask or the like sample is charged by irradiation with a charged particle beam, the charging is liable to hamper image observation, inspection and handling. Therefore, the sample and the surface or vicinity of the sample being charged by an electron beam or the like is held in an atmosphere or a reduced pressure atmosphere or in a predetermined gaseous atmosphere within a preliminary evacuation chamber, a sample chamber or the like, containing a soft X-ray generator which irradiates the sample or the vicinity thereof with soft X-rays which are controlled to generate positive ions and negative ions and remove charges on the surface of the sample.

### CROSS REFERENCE TO RELATED APPLICATIONS

This application is based on and hereby claims priority to Japanese Patent Application No. 2005-176156 filed on Jun. 16, 2005, the contents of which are hereby incorporated by reference.

### BACKGROUND

The present invention relates to a charged particle beam apparatus for observing, inspecting and working the surface of a semiconductor wafer, a photomask or the like sample which is liable to be charged by charged particle beam irradiation and to have its image observation hampered, and a method for generating a charged particle beam image.

Heretofore, a field emission type scanning electron microscope (FE-SEM) has been employed for the observation and pattern length measurement of a semiconductor wafer or photomask surface. Besides, a focused ion beam apparatus (FIB) has been employed for the revision of a photomask pattern. Since, however, that surface of a sample which is to be observed or to be subjected to the length measurement is wholly or partly made of a nonconductive material, the surface is charged by irradiation with charged particles, and the charging sometimes hampers the observation or length measurement, or working.

It is therefore practiced that the sample is placed in the atmospheric air or an atmosphere in which the pressure of the atmospheric air is reduced, or in any other gaseous atmosphere, and that the sample is irradiated with ultraviolet radiation, thereby to generate positive ions or negative ions and to neutralize (remove) the charges on the sample.

However, there have been problems as stated below, with the above technique wherein the sample in the reduced pressure atmosphere is irradiated with the ultraviolet radiation emitted from a deuterium lamp, thereby to generate the positive ions or negative ions and to neutralize the charges on the sample and remove the charging.
1. In a ground state where a gas atom or molecule is neutral and stable, electrons exist at an orbit of lowest energy level.
2. When one photon (one photon of the ultraviolet radiation), for example, impinges on the gas atom or molecule and is absorbed by it, one electron migrates onto an outer orbit of corresponding level (the electron undergoes so-called “excitation”). In this state, the gas atom or molecule is electrically neutral, but it is in an unstable state and returns into the original ground state in about 1-2 second(s).
3. When the gas atom or molecule is struck by another photon (one photon of the ultraviolet radiation) and absorbs energy before returning into the ground state, the excited electron obtains energy still further, whereby the electron spins out of the orbit and is perfectly liberated from the constraint of the atom or molecule. As a result, there are formed both a positive ion (the original atom or molecule having released the electron) and a negative ion in which the released electron has combined with another neutral molecule (or neutral atom) in a short time.
4. In addition, the charges on the sample are neutralized by the positive ion or negative ion formed, and the charging is removed.

With the UV radiation, however, the neutral gas atom or molecule cannot be ionized by only the energy of one photon, and the positive ion and negative ion are formed by the energy of, for example, two photons. Therefore, there have been such problems that an efficiency for generating the ions is low, and that an intense UV radiation is required.

### SUMMARY

In order to solve these problems, in a charged particle beam apparatus wherein a secondary electron beam or the like which is emitted from a sample by irradiating the sample with a charged particle beam is detected so as to generate an image, the present invention has for its object to efficiently remove the charges of the surface of the sample by heightening the generation efficiencies of positive ions and negative ions, in such a way that the sample is irradiated with soft X-ray being higher in energy than UV radiation, in a state where the surface or vicinity of the sample charged by an electron beam or the like is held in the atmosphere or a reduced pressure atmosphere or in a predetermined gaseous atmosphere within a preliminary evacuation chamber, a sample chamber or the like.

In a charged particle beam apparatus wherein a secondary electron beam or the like which is emitted from a sample by irradiating the sample with a charged particle beam is detected so as to generate an image, the present invention makes it possible to efficiently remove the charges of the surface of the sample by heightening the generation efficiencies of positive ions and negative ions, in such a way that the sample is irradiated with soft X-ray being higher in energy than UV radiation, in a state where the surface or vicinity of the sample charged by an electron beam or the like is held in the atmosphere or a reduced pressure atmosphere or in a predetermined gaseous atmosphere within a preliminary evacuation chamber, a sample chamber or the like.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of system architectural diagram of the present invention.

FIG. 2 is a flow chart for explaining the operation of the present invention.

FIG. 3 is a schematic diagram of an example of an X-ray generator.

FIG. 4 is a schematic diagram for explaining the present invention.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

In a charged particle beam apparatus wherein a secondary electron beam or the like which is emitted from a sample by irradiating the sample with a charged particle beam is detected so as to generate an image, the present invention has realized to efficiently remove the charges of the surface of the sample by heightening the generation efficiencies of positive ions and negative ions, in such a way that the sample is irradiated with soft X-ray being higher in energy than UV radiation, in a state where the surface or vicinity of the sample charged by an electron beam or the like is held in the atmosphere or a reduced pressure atmosphere or in a predetermined gaseous atmosphere within a preliminary evacuation chamber, a sample chamber or the like.

### Embodiment 1

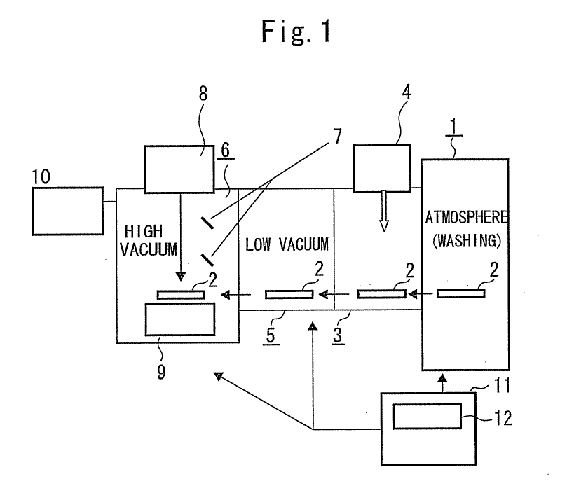

FIG. 1 shows a system architectural diagram of the present invention. In the ensuing embodiment, an example which employs an electron beam among charged particle beams (the electron beam, an ion beam, etc. that are particle beams having charges), and in which a sample (mask) is subjected to plane scanning (scanning in an X-direction and a Y-direction) in a state where it is irradiated with the electron beam finely focused, so as to generate an image (termed a “secondary electron image”) by detecting and amplifying secondary electrons emitted from the sample, will be successively described in detail below. Incidentally, the same holds true of the other charged particle beam (such as the ion beam), and just as the image is obtained in such a way that the secondary electrons emitted by irradiating the sample with the electron beam are detected and amplified as will be stated below, it is also allowed to generate an image obtained by detecting and amplifying a transmitted electron beam or a reflected electron beam (the transmitted image or reflected image of a so-called “SEM” (scanning electron microscope), or to generate an image obtained by irradiating the whole surface of the sample with the electron beam and then detecting and amplifying a transmitted electron beam with a CCD (or a CCD camera) (the transmitted image of a so-called “STEM” (scanning transmission electron microscope)).

Referring to FIG. 1, a mask magazine 1 is a magazine in which masks 2 being samples are accommodated in large numbers, and the interior of which is clean. The mask 2 is a mask for exposing a semiconductor pattern or the like to light.

A preliminary chamber 3 is a room which serves to mount the mask magazine 1 and to accept the mask 2 within the mask magazine 1 in a cleaned state and then temporarily keep this mask in custody, and which serves to convey the processed mask 2 into the mask magazine 1 in a cleaned state. The preliminary chamber 3 is usually held at the atmospheric pressure, but if necessary, it may well be evacuated into a low vacuum (low vacuum of from the atmospheric pressure to about 0.1 Torr) after accepting the mask 2 and closing a gate, not shown, disposed at its boundary with the mask magazine 1. Incidentally, a “room” in which the mask 2 is irradiated with soft X-ray as stated in the claims is a room in which an X-ray generator 4 is mounted, such as a subchamber 5 or the preliminary chamber 3, except a main chamber 6 in FIG. 1 (termed a “sample chamber” in the claims).

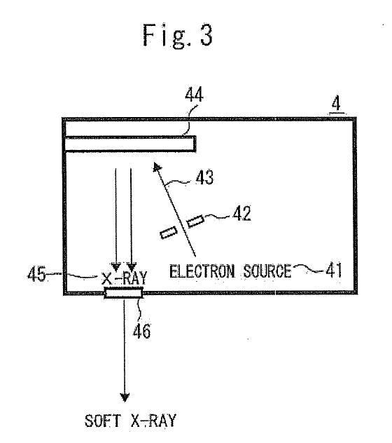

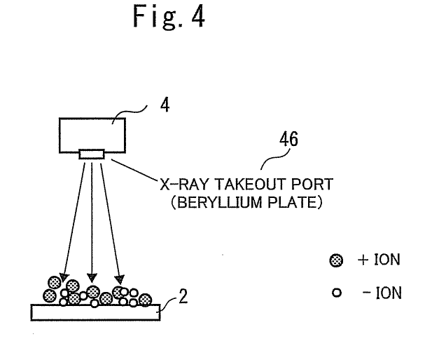

The X-ray generator 4 is for generating the soft X-ray and irradiating the mask 2 with the soft X-ray so as to remove the charges of the mask 2 (refer to FIGS. 3 and 4).

The subchamber 5 is the room in which the surroundings of the mask 2 are evacuated into a low vacuum, and which is interposed between the preliminary chamber 3 and the min chamber 6 here.

The main chamber 6 is a room of vacuum (usually, of about 10-6 Torr), which serves to place the mask 2 on a stage 9, to scan the surface of the mask 2 being the sample (as the plane scanning in the X- and Y-directions), by a charged particle optical system 8, here, with the finely focused electron beam, and to detect and amplify the emitted secondary electrons by a secondary electron detector 7 and then generate the image (secondary electron image).

The secondary electron detector 7 is one which detects and amplifies the secondary electrons emitted from the mask 2, and which collects and then detects and amplifies the secondary electrons emitted from the mask 2 by applying a positive voltage thereto. By the way, in case of detecting the reflected electrons, light or X-rays emitted from the mask 2, a corresponding detector (a reflected electron detector, a light detector or an X-ray detector) is disposed instead of the secondary electron detector 7.

The charged particle optical system 8 is for generating charged particles and irradiating the mask 2 with the charged particles, and in the case of the SEM, it is for generating and finely focusing the electron beam and for subjecting the surface of the mask 2 to the plane scanning (scanning in the X- and Y-directions). In the case of the STEM, it is for generating the electron beam and irradiating the whole surface of the mask 2 with the electron beam.

The stage 9 is a rest on which the mask 2 is placed, and which is moved in the X- and Y-directions. Regarding the X-directional and Y-directional movement magnitudes of the mask 2 placed on the stage 9, the position of the mask 2 is measured at a high precision in real time by a laser interferometer or the like, not shown, and a personal computer (control portion) 11 controls the mask 2 to a predetermined position on the basis of measured positional information.

An image 10 is the image (so-called “secondary electron image”) or the like which has been obtained by subjecting the mask 2 to the plane scanning with the electron beam, detecting and amplifying the secondary electrons, and performing a brilliance modulation, and which is indicated on a display.

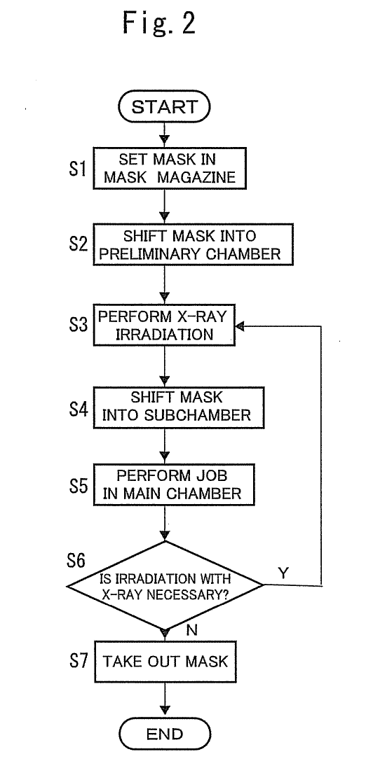

The personal computer (control portion) 11 is a control portion which controls the entirety of the apparatus shown in FIG. 1, and here, it is configured of X-ray irradiation means 12, etc. (it performs the control in accordance with, for example, a flow chart in FIG. 2).

Next, the operation of the configuration in FIG. 1 will be described in detail in the order of the flow chart in FIG. 2. FIG. 2 shows the flow chart for explaining the operation of the present invention.

Referring to FIG. 2, “S1” sets the mask 2 in the mask magazine 1. This sets the mask 2 to have its pattern size measured by the apparatus in FIG. 1, in the mask magazine 1, or sets the mask 2 to have its pattern size measured by the apparatus in FIG. 1, in the mask magazine 1 and mounts the mask 2 at the illustrated position, within a clean room not shown.

“S2” conveys the mask 2 into the preliminary chamber 3. This takes out the mask 2 set in the mask magazine 1 at the S1, by a mechanism (robot) not shown and conveys the mask 2 to the illustrated position thereof in the preliminary chamber 3. In addition, if necessary, the interior of the preliminary chamber 3 is adjusted to a predetermined pressure within a range of from the atmospheric pressure to 0.1 Torr (or the interior of the preliminary chamber 3 is adjusted to a predetermined pressure with a predetermined gas (oxygen, nitrogen, an inert gas or the mixed gas thereof)).

“S3” performs X-ray irradiation. This irradiates the mask 2 conveyed into the preliminary chamber 3 at the S2, with the soft X-ray from the X-ray generator 4 (refer to FIG. 3 to be explained later), from above the mask 2 for a predetermined time period, thereby to generate positive ions and negative ions in the vicinity of the surface of the mask 2 and to remove (neutralize) the charges on the surface of the mask 2. Here, an intensity at which the mask 2 is irradiated with the soft X-ray is adjusted by the distance between the X-ray generator 4 and the mask 2, and the irradiation time period is adjusted to a time period for which the soft X-ray is generated (the X-ray irradiation means 12 constituting the personal computer (control portion) 11 in FIG. 1 adjusts the time period). Usually, the distance is from 30 cm to 1.5 m, and the irradiation time period is from 20 seconds to 60 seconds (the distance and the irradiation time period are not limited to the above examples, but they are determined at will by experimentally obtaining the optimum values with which the charges of the mask 2 are removed). Here, in case of the mask 2 bearing a resist, the irradiation is somewhat weakened (the distance is set at, for example, at least 1 m, or the irradiation time period is shortened to, for example, 20 seconds) in order to avoid influence (the change of a size, etc.) on the pattern of the mask 2 due to the irradiation with the soft X-ray, whereas in case of the mask 2 not bearing the resist, the irradiation is somewhat strengthened (the distance is set at, for example, at most 1 m, or the irradiation time period is somewhat lengthened to, for example, 30 seconds) so that the charges of the mask 2 may be sufficiently neutralized (removed). Besides, in an experiment, about 15 mSV/h2 was used as the intensity of the soft X-ray (“SV” denotes Sievert, while “h” denotes hour, and the intensity was a numerical value at a position being 1 m distant and was about 1/5000 of an intensity for use in the roentgenography of a breast medical examination). Incidentally, since the soft X-ray is used in the present invention, it can be easily intercepted by glass or thin metal, and it is prevented from leaking outside.

“S4” shifts the mask 2 into the subchamber 5. This shifts the mask 2 into the subchamber 5 in FIG. 1 after the charges of the mask 2 have been removed (neutralized) by the X-ray irradiation at the S3. In addition, the main chamber 6 is preliminarily evacuated, that is, the main chamber 6 is evacuated (preliminarily evacuated) to the extent that the pressure of the main chamber 6 does not influence the operation thereof even when a partition valve, not shown, disposed between the subchamber 5 and the main chamber 6 is opened.

“S5” performs a job in the main chamber 6. By way of example, the mask 2 is placed on the stage 9 of the main chamber 6, and in the state where the mask 2 is irradiated with the finely focused electron beam from the charged particle optical system 8, the mask 2 is subjected to the plane scanning with the electron beam. The secondary electrons thus emitted are detected and amplified by the secondary electron detector 7, and the image (secondary electron image) 10 is displayed. In addition, the measurement of the size of the predetermined pattern of the mask 2, or the like is performed on the image 10.

“S6” discriminates if irradiation with the X-ray is necessary. This judges charging in such a case where, during the job (during the measurement) at the S5, in a place which is currently under the measurement or a specified place which is periodically displayed, the color tone (the tone of white and black) of the image has changed more than a predetermined value, or the position of the image has changed more than a predetermined value, thereby to discriminate if the irradiation with the X-ray is necessary (if the removal (neutralization) of stored charges is necessary). In case of “YES”, the flow returns to the S3, at which the removal of the charges of the mask 2, etc. are performed by the X-ray irradiation, and the job is started at the S4 and S5 again (the job is restarted from the place of temporary stop, or it is started from a predetermined preceding place or from the beginning). On the other hand, in case of “NO” at the S6, the irradiation with the X-ray has been discriminated unnecessary, and hence, the mask 2 is taken out of the apparatus at “S7” (the mask 2 within the main chamber 6 in FIG. 1 is conveyed into and accommodated in the mask magazine 1 via the subchamber 5 and the preliminary chamber 3). Incidentally, it is also allowed that, when the mask 2 has been conveyed into the preliminary chamber 3 after the end of the job of the mask 2 corresponding to “NO” at the S6, the mask 2 is irradiated with the X-ray in the same manner as at the S3, so as to perfectly remove (neutralize) charges which have been stored during the job performed by irradiating the mask 2 with the electron beam, and that the mask 2 is thereafter accommodated in the mask magazine 1. That is,
before the mask 2 is conveyed into the main chamber 6, it is irradiated with the soft X-ray so as to remove (neutralize) the charges, or
during the job in which the mask 2 is placed on the stage 9 of the main chamber 6, the job is temporarily stopped, the mask 2 is brought back into the preliminary chamber 3 (or is held in the main chamber 6) and is irradiated with the soft X-ray in a predetermined atmosphere so as to remove the charges, whereupon the job is started again.
After the end of the job in which the mask 2 is placed on the stage 9 of the main chamber 6, this mask 2 is brought back into the preliminary chamber 3 and is irradiated with the soft X-ray so as to perfectly remove the charges, whereupon the mask 2 is accommodated in the mask magazine 1. In addition, the mask 2 proceeds to the next process.

In the above way, it is permitted to remove the charges by irradiating the mask 2 with the soft X-ray, before this mask 2 is placed on the stage 9 of the main chamber 6; to temporarily stop the job in the course of this job in which the mask 2 is placed on the stage 9, to remove the charges by irradiating the mask 2 with the soft X-ray, and to thereafter restart the job; or to remove the charges by irradiating the mask 2 with the soft X-ray after the end of the job.

Incidentally, although the irradiation of the mask 2 with the soft X-ray has been performed in the preliminary chamber 3, the charges may well be removed in such a way that the subchamber 5, and further the main chamber 6 are brought into an atmosphere of from the atmospheric pressure to about 0.1 Torr (an atmosphere of any of air, oxygen, nitrogen and an inert gas, or a combined gas consisting of at least two of them), and that the mask 2 is irradiated with the soft X-ray.

FIG. 3 shows an example of the X-ray generator in the present invention. The illustrated X-ray generator 4 is of reflection type and has the form of a lamp. The reflection type X-ray generator 4 is such that electrons generated from an electron source 41 are accelerated (accelerated at, for example, several kV to one hundred and several tens kV) and focused by an acceleration electrode 42 so as to be projected onto a target (tungsten) 44, and that soft X-ray which is emitted in the aspect of being reflected downwards from the target 44 (continuous soft X-ray, or soft X-ray further containing characteristic X-ray, which is emitted when the electrons accelerated to several kV to one hundred and several tens kV are projected onto the target 44) is taken outside (under the atmospheric pressure or a predetermined reduced pressure) through a thin beryllium plate 46 (since the interior of the beryllium plate 46 is vacuum, this beryllium plate 46 is a material absorbing the soft X-ray little).

The above structure is bestowed on the illustrated reflection type X-ray generator 4 in the lamp form, whereby the soft X-ray can be easily generated and taken out so as to irradiate the whole surface of the mask 2 under the structure of FIG. 1.

FIG. 4 shows a diagram for explaining the present invention. This illustrates that, in a case where the surface of the sample (mask) 2 is irradiated with the soft X-ray derived from the X-ray takeout port (beryllium plate) 46 of the X-ray generator 44, the molecules (atoms) of air irradiated with the soft X-ray are excited, so positive ions (+ ions, namely, the molecules (atoms) of the air having positive charges) and negative ions (− ions, namely, the molecules (atoms) of the air having negative charges (electrons)) are generated in the vicinity of the surface of the sample 2, and negative charges (electrons) stored on the surface of the sample 2 are neutralized (removed) by the positive ions. On the other hand, positive charges stored on the surface of the sample 2 are neutralized (removed) by the negative ions.

As described above, when the surface of the sample (mask) 2 or the vicinity thereof is irradiated with the soft X-ray emitted from the X-ray generator 4, both the positive ions and the negative ions are generated in the vicinity of the surface of the sample 2, and it is permitted to remove (neutralize) both the charges (positive charges and negative charges) of the sample 2.

On this occasion, as an atmosphere in the vicinity of the surface of the sample (mask) 2, in a state where any of the air, oxygen, nitrogen, an inert gas, etc., or a mixed gas consisting of at least two of them, has its pressure held within a range of from the atmospheric pressure to about 0.1 Torr, the sample 2 is irradiated with the soft X-ray, whereby the positive ions and the negative ions can be efficiently generated to remove (neutralize) the charges of the sample 2.

### INDUSTRIAL APPLICABILITY

In a charged particle beam apparatus wherein a secondary electron beam or the like which is emitted from a sample by irradiating the sample with a charged particle beam is detected so as to generate an image, the present invention relates to a charged particle beam apparatus and a method for generating a charged particle beam image, in which the sample is irradiated with soft X-ray in a state where the surface or vicinity of the sample charged by an electron beam or the like is held in the atmosphere or a reduced pressure atmosphere or in a predetermined gaseous atmosphere within a preliminary evacuation chamber, a sample chamber or the like, whereby the charges of the surface of the sample are efficiently removed by heightening the generation efficiencies of positive ions and negative ions.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A charged particle beam apparatus used with a sample chamber or a predetermined room, comprising:
a lens system which irradiates a sample with a charged particle beam;
image generation means for generating an image by detecting an electron beam or the like which has been emitted or transmitted through irradiation of the sample with the charged particle beam;
a soft X-ray generator, arranged in the sample chamber or in the predetermined room, which irradiates the sample or the vicinity thereof with soft X-ray; and
means for controlling said soft X-ray generator to irradiate the sample or the vicinity thereof with the generated soft X-ray in a state and to maintain in the sample chamber or the predetermined room a predetermined atmosphere to generate positive ions and negative ions and to control removal of charges on a surface of the sample.

2. A charged particle beam apparatus as defined in claim 1, wherein the sample or the vicinity thereof is irradiated with the soft X-ray, thereby to remove the charges, before the image of the sample is generated or/and after the generation of the image has ended.

3. A charged particle beam apparatus as defined in claim 2, wherein the generation of the image is temporarily stopped in course of the generation of the image of the sample, and that the sample or the vicinity thereof is irradiated with the soft X-ray, thereby to remove the charges, whereupon the generation of the image is restarted.

4. A charged particle beam apparatus as defined in claim 3, further comprising a mechanism which adjusts a distance between said soft X-ray generator and the sample, at will.

5. A charged particle beam apparatus as defined in claim 4, wherein the distance between the soft X-ray generation device and the sample is set within a range of from 30 cm to 150 cm.

6. A charged particle beam apparatus as defined in claim 5, wherein the predetermined atmosphere is selected from the group consisting of air, oxygen, nitrogen, an inert gas, and combinations thereof.

7. A charged particle beam apparatus as defined in claim 6, wherein a pressure of the atmosphere is set within a range between 0.1 Torr and atmospheric pressure.

8. Using a charged particle beam apparatus including a lens system which irradiates a sample with a charged particle beam, and an image generator generating an image by detecting an electron beam or the like which has been emitted or transmitted through the irradiation of the sample with the charged particle beam; a charged-particle-beam-image generation method comprising:
disposing a soft X-ray generator which is arranged in a sample chamber for receiving the sample therein or in a predetermined room, and which irradiates the sample or the vicinity thereof with soft X-ray;
controlling the soft X-ray generator and irradiating the sample or the vicinity thereof with the generated soft X-ray in a state; and
maintaining in the sample chamber or the predetermined room a predetermined atmosphere to generate positive ions and negative ions and to control removal of charges on a surface of the sample.

9. A charged-particle-beam-image generation method as defined in claim 8, wherein the sample or the vicinity thereof is irradiated with the soft X-ray to remove the charges, before the image of the sample is generated, after the generation of the image has ended, or/and by temporarily stopping the generation of the image in course of the image generation.

10. A charged particle beam apparatus as defined in claim 1, wherein the generation of the image is temporarily stopped in course of the generation of the image of the sample, and that the sample or the vicinity thereof is irradiated with the soft X-ray, thereby to remove the charges, whereupon the generation of the image is restarted.

11. A charged particle beam apparatus as defined in claim 1, further comprising a mechanism which adjusts a distance between said soft X-ray generator and the sample, at will.

12. A charged particle beam apparatus as defined in claim 11, wherein the distance between the soft X-ray generation device and the sample is set within a range of from 30 cm to 150 cm.

13. A charged particle beam apparatus as defined in claim 1, wherein the predetermined atmosphere is selected from the group consisting of air, oxygen, nitrogen, an inert gas, and combinations thereof.

14. A charged particle beam apparatus as defined in claim 1, wherein a pressure of the atmosphere is set within a range between 0.1 Torr and atmospheric pressure.
